(19) United States
(12) Patent Application Publication
(10) Pub. No.: US 2026/0214620 A1
(43) Pub. Date: Jul. 23, 2026

(54) Receiving a Request for a Location of a User Equipment

(71) Applicant: Telefonaktiebolaget LM Ericsson (publ), Stockholm (SE)

(72) Inventors: Ritesh Shreevastav, Upplands Väsby (SE); Richárd Bátorfi, Budapest (HU)

(21) Appl. No.: 19/142,490

(22) PCT Filed: Jan. 2, 2024
(86) PCT No.: PCT/SE2024/050001

§ 371 Date: Jun. 23, 2025

Related U.S. Application Data
(60) Provisional application No. 63/437,804, filed on Jan. 9, 2023.

(51) Int. Cl. H04W 64/00; H04W 12/06; H04W 24/10

(52) U.S. Cl. CPC H04W 64/00; H04W 12/06; H04W 24/10

(57) ABSTRACT

Methods and apparatus are provided, including in an example a method in a first network node for a network assisted positioning procedure The method comprises receiving, from a second network node, a request for a location of a User Equipment (UE), wherein the request indicates that the UE is a Positioning Reference Unit (PRU) and the request includes a correlation identifier. The method also comprises determining, based on the identifier, whether the UE is a PRU.

### TECHNICAL FIELD

Examples of this disclosure relate to receiving a request for a location of a User Equipment (UE).

### BACKGROUND

Positioning of a User Equipment (UE) has been a topic in Long Term Evolution (LTE) standardization since 3GPP Release 9. The primary objective is to fulfill regulatory requirements for emergency call positioning. Positioning in New Radio (NR) is proposed to be supported by the architecture shown in FIG. 1, which illustrates Next Generation Radio Access Network (NG-RAN) Release 15 Location Services (LCS) protocols. Location Management Function (LMF) is the location node in New Radio (NR). There are also interactions between the location node and the gNodeB via the NR positioning protocol A (NRPPa) protocol. The interactions between the gNodeB and the device (e.g. UE) are supported via the Radio Resource Control (RRC) protocol.

In the legacy LTE standards, the following techniques are supported:
1. Enhanced Cell ID. Essentially cell ID information to associate the device to the serving area of a serving cell, and then additional information to determine a finer granularity position.
2. Assisted GNSS (Global Navigation Satellite System). GNSS information retrieved by the device, supported by assistance information provided to the device from Evolved Serving Mobile Location Center (E-SMLC).
3. OTDOA (Observed Time Difference of Arrival). The device estimates the time difference of reference signals from different base stations and sends to the E-SMLC for multilateration.
4. UTDOA (Uplink TDOA). The device is requested to transmit a specific waveform that is detected by multiple location measurement units (e.g. an eNB) at known positions. These measurements are forwarded to E-SMLC (Evolved Serving Mobile Location Centre, illustrated in FIG. 1) for multilateration.
5. Sensor methods such as Biometric pressure sensor which provides vertical position of the device and Inertial Motion Unit (IMU) which provides displacement information.

NR supports below Radio Access Technology (RAT) Dependent positioning methods:
DL-TDOA: The downlink (DL) TDOA positioning method makes use of the DL reference signal time difference (RSTD), and optionally DL positioning reference signal (PRS)-reference signal received power (RSRP), of downlink signals received from multiple transmission points (TPs), at the UE. The UE measures the DL reference signal timing difference (RSTD) (and optionally DL positioning reference signal (PRS) reference signal received power (RSRP)) of the received signals using assistance data received from the positioning server, and the resulting measurements are used along with other configuration information to locate the UE in relation to the neighbouring TPs.
Multi-RTT: The Multi-round trip time (RTT) positioning method makes use of UE Rx-Tx measurements and DL PRS RSRP of downlink signals received from multiple transmission reception points (TRPs), measured by the UE and the measured gNB Rx-Tx measurements and uplink (UL) sounding reference signal (SRS)-RSRP at multiple TRPs of uplink signals transmitted from UE.
UL-TDOA: The UL TDOA positioning method makes use of the UL TDOA (and optionally UL sounding reference signal (SRS)-RSRP) at multiple reception points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.
DL-AoD: The DL Angle of Departure (AoD) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.
UL-AoA: The UL Angle of Arrival (AoA) positioning method makes use of the measured azimuth (A) and zenith (Z) of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.
NR-ECID: NR Enhanced Cell ID (NR E-CID) positioning refers to techniques which use additional UE measurements and/or NR radio resource and other measurements to improve the UE location estimate.

The positioning modes can be categorized in below three areas:
UE-Assisted: The UE performs measurements with or without assistance from the network and sends these measurements to the E-SMLC where the position calculation may take place.
UE-Based: The UE performs measurements and calculates its own position with assistance from the network.

Standalone: The UE performs measurements and calculates its own without network assistance.

FIG. 2 illustrates the initiation and reporting of location events for a deferred 5GC-MT-LR procedure for Periodic, Triggered and UE Available Location Events, according to 3GPP TS 23.273 version 16.5.0. The procedure supports mobility of a UE within a Virtual Public Land Mobile Network (VPLMN) 5G Core Network (5GCN) and from a 5GCN to an Evolved Packet Core (EPC). The procedure is described in 3GPP TS 23.273 version 16.5.0, chapter 6.3.1, and involves the following steps.
1. The external location services client or the Application Function, AF (via Network Exposure Function, NEF) sends a request to the (Home) Gateway Mobile Location Centre (GMLC) for location reporting for periodic, triggered or UE available location events. The request is sent as described for step 1 in clause 6.1.2 of 3GPP TS 23.273 with the differences described here. The Location Services (LCS) Service Request provides the type of periodic or triggered location reporting being requested and associated parameters. For periodic location, the LCS Service Request includes the time interval between successive location reports, the total number of reports and may include location Quality of Service (QOS). For periodic location reporting, the LCS Service Request may include a scheduled location time for the first periodic location report. For area event reporting, the LCS Service Request includes details of the target geographical area, whether the event to be reported is the UE being inside, entering into or leaving the target area, the duration of event reporting, the minimum and maximum time intervals between successive event reports, the maximum event sampling interval, whether location estimates shall be included in event reports (and associated location QoS), and whether only one location report is required or more than one. If the target area is expressed by a local coordinate system or a geopolitical name, the (H)GMLC shall convert the target area to a geographical area expressed by a shape as defined in TS 23.032. For motion event reporting, the LCS Service Request includes the threshold linear distance, the duration of event reporting, the minimum and maximum time intervals between successive event reports, the maximum event sampling interval, whether location estimates shall be included in event reports (and associated location QoS), and whether only one location report is required or more than one.
1 b-1 AF invokes the Nnef_EventExposure_Subscribe service operation to the NEF.
1b-2 The NEF forwards the request to the (H)GMLC. The NEF assigns a LDR refence number locally and sends it to (H)GMLC,
2. The (H)GMLC may verify UE privacy requirements as for step 2 in clause 6.1.2. The (H)GMLC may also subscribe to and receive notification of UE privacy profile updates according to steps 0 and 4 of clause 6.12.1.
3. The (H)GMLC queries the Unified Data Management (UDM) for the Access and Mobility Management Function (AMF) address and, in the case of roaming, a Visited (V)GMLC address as for step 3 in clause 6.1.2.
NOTE 1: The HGMLC may also query the Home Subscriber Server (HSS) of the target UE for a serving Mobility Management Entity (MME) address as described in clause 9.1.1 of TS 23.271. The deferred EPC-MT-LR procedure for Periodic and Triggered Location described in clause 9.1.19 of TS 23.271 or the EPC-MT-LR procedure for the UE availability event described in clause 9.1.15 of TS 23.271 may then be performed instead of steps 4-31—e.g. if the HSS returns an MME address but the UDM does not return an AMF address.
4. This step is skipped for a non-roaming UE. For a roaming UE, the HGMLC obtains a VGMLC address if not received at step 3 and invokes the Ngmlc_Location_Provide Location Request service operation to forward the location request to the VGMLC as described for step 4 of in clause 6.1.2. The (H)GMLC also includes a contact address for the (H)GMLC (Notification Target Address, e.g. a URI) and an LDR reference number (Notification correlation ID) to be used for event reporting at steps 20 and 29. The LDR reference number is either allocated by (H)GMLC based on predefined rule, e.g. operator's policy if the location request is received in step 1a, or allocated by NEF, if the location request is received in step 1b.
5. The (H)GMLC or VGMLC invokes the Namf_Location_ProvidePositioningInfo Request service operation to forward the location request to the serving AMF as described for step 5 in clause 6.1.2 and includes the (H)GMLC contact address and LDR reference number. The LDR reference number is either allocated by (H)GMLC based on predefined rule, e.g. operator's policy if the location request is received in step 1a, or allocated by NEF, if the location request is received in step 1b. For area event reporting, the target geographical area is converted into a corresponding list of cell and/or tracking area identities.
6-8. If the AMF supports a deferred location request, the AMF returns an acknowledgment to the external LCS client, via the (H)GMLC and, in the case of roaming, the VGMLC, indicating that the request for deferred location was accepted. The VGMLC, when used, may optionally release resources for the deferred location request at this point.
9. If the UE is not currently reachable (e.g. is using eDRX or PSM), the AMF waits for the UE to become reachable.
NOTE 2: In the event of mobility of the UE to another AMF or to EPC when the UE becomes reachable, the old AMF can return an event indication to the (H)GMLC as at steps 19 and 20 and may include the address of the new serving AMF or MME if known. If a new serving AMF or MME is not known, the (H)GMLC can repeat step 3 to query the UDM and HSS for the new AMF or MME address. If a new AMF address is received, the (H)GMLC can restart the procedure from step 4.
10. Once the UE is reachable, if the UE is then in Connected Mode (CM) IDLE state, the AMF initiates a network triggered Service Request procedure as defined in clause 4.2.3.3 of TS 23.502 to establish a signalling connection with the UE.
NOTE 3: The AMF may decide to cancel the location request before the UE becomes reachable (e.g. due to lack of resources or due to a timeout on the UE becoming reachable) or when the UE becomes reachable (e.g. if the AMF executes NAS level congestion control on the UE, or for other reasons). The AMF then skips steps 10-18 and proceeds to step 19 to return an indication of location cancelation to the VGMLC or (H)GMLC.
11-12. The AMF performs steps 7-8 in clause 6.1.2 to notify the UE of the location request and verify privacy requirements if required by the location request received at step 5 and supported by the UE. The AMF includes in the notification to the UE the type of deferred location request in the case of periodic or triggered location.
13. The AMF selects an LMF as described for step 6 in clause 6.1.1. The selection may take into account the type of deferred location request (e.g. whether periodic or triggered) and any parameters for the deferred location request (e.g. the number of event reports required and/or the duration).
14. The AMF invokes the NImf_Location_DetermineLocation Request service operation towards the LMF to initiate a request for deferred UE location. For a request for periodic or triggered location, the service operation includes all the information received in step 4 or step 5 including the (H)GMLC contact address, LDR reference number, UE Positioning Capability if available and any scheduled location time and may include a list of allowed access types for event reporting at step 22. For a request for the UE available location event, the (H)GMLC contact address and LDR reference number are not included. In all cases, the service operation includes an LCS Correlation identifier, the AMF identifier, the serving cell identity, the client type and may include an indication if UE supports LTE positioning protocol (LPP), the required QoS and Supported GAD shapes.
15. The LMF performs one or more of the positioning procedures described in clause 6.11.1, 6.11.2 and 6.11.3 and as described for step 8 in clause 6.1.1. During this step, the LMF may request and obtain the UE positioning capabilities (e.g. which may indicate the type(s) of periodic and triggered location supported by the UE and the access types supported by the UE for event reporting). The LMF may also obtain the UE location e.g. for a request for the UE available location event or when an initial location is requested for periodic or triggered UE location. For a request for the UE available location event, the LMF skips steps 16 and 17.
16. If periodic or triggered location was requested, the LMF sends a supplementary services LCS Periodic-Triggered Invoke Request to the UE via the serving AMF by invoking the Namf_Communication_N1N2MessageTransfer service operation. The LCS Periodic-Triggered Location Invoke carries the location request information received from the AMF at step 14, including the (H)GMLC contact address, LDR reference number and any scheduled location time. The LCS Periodic-Triggered Location Invoke also includes a deferred routing identifier, which can be the identification of the LMF when the LMF will act as a serving LMF or a default LMF identification otherwise. The LCS Periodic-Triggered Location Invoke may indicate the allowed access types for event reporting at step 25 (e.g. one or more of NR, E-UTRA connected to 5GC, non- 3GPP access connected to 5GC, any of the RAT Types specified for NR satellite access) and may include embedded positioning message(s) which indicates certain allowed or required location measurements (or a location estimate and the timestamp of the location estimate if available) at step 24 for each location event reported (e.g. based on the positioning capabilities of the UE obtained in step 14 and the allowed access types). As part of NAS transport of the LCS Periodic-Triggered Location Invoke from the serving AMF to the UE, the serving AMF includes an immediate routing identifier in the NAS transport message containing an LCS Correlation identifier-e.g. according to clause 6.11.1.
NOTE 4: The deferred routing identifier may be global (e.g. an IP address, UUID or URI) or may be local. The deferred routing identifier is used for routing in step 25. However, the immediate routing identifier included by the AMF in step 15 is used for routing in step 17.
17. If the request in step 16 can be supported, the UE returns a supplementary services acknowledgment to the LMF, which is transferred via the serving AMF using the immediate routing identifier and delivered to the LMF using an Namf_Communication_N1MessageNotify service operation.
18. The LMF invokes the NImf_Location_DetermineLocation Response service operation towards the AMF to respond to the request at step 14. For a request for the UE available location event, the response includes any UE location obtained at step 15 and the LMF then releases all resources. For a periodic or triggered location request, the response includes any location obtained at step 15, a confirmation of whether periodic or triggered location was successfully activated in the UE according to steps 16 and 17 and the identification of the LMF in the case of successful activation with a serving LMF; the LMF also retains state information and resources for later steps if the LMF acts a serving LMF. If the multiple QoS class was used in the location request, the LMF provides the achieved Location QOS Accuracy in step 15. If the UE cannot support the periodic and triggered location request, the service operation returned to the AMF shall include a suitable error cause. The service operation also includes the UE Positioning Capability if the UE Positioning Capability is received in step 15 including an indication that the capabilities are non-variable and not received from AMF in step 14.
19. The AMF invokes the Namf_Location_EventNotify service operation towards the VGMLC for roaming, or (H)GMLC for non-roaming, and includes any location received at step 18 and, for periodic or triggered location, a confirmation of whether or not periodic or triggered location was successfully activated in the target UE. The VGMLC, if used, may be the same VGMLC used in steps 5 and 6 or may be a different VGMLC. In the case of a different VGMLC, the AMF includes the HGMLC contact address and LDR reference number. The AMF also includes the LMF identification and the achieved Location QoS Accuracy if received at step 18. The AMF may then release all resources for the location request and cease support for the procedure.
20. This step is skipped for a non-roaming UE. For a roaming UE, The VGMLC forwards the response received at step 19 to the HGMLC using the HGMLC contact address received at step 19 (for a different VGMLC) or received and stored at step 4 (for the same VGMLC) and includes the LDR reference number and any LMF identification that was received. The VGMLC may then release all resources for the location request and cease support for the procedure.
NOTE 5: As an optional optimization for a roaming UE, instead of performing steps 19 and 20, the AMF may invoke the Namf_Location_EventNotify service operation directly towards the HGMLC (e.g. if a VGMLC is not used or if the VGMLC ceases support after step 8).
21. The (H)GMLC forwards the response to the external LCS client or AF (via the NEF). If the location request at step 1 was for the UE available location event, the procedure terminates here and further steps 22-31 are not performed.
22. For a periodic or triggered location request where steps 16 and 17 were successfully performed, the UE monitors for occurrence of the trigger or periodic event requested in step 16. For the area event or motion event, the UE monitors the requested event at intervals equal to or less than the maximum event sampling interval. An event trigger is detected by the UE when any of the following occur: (i) a requested area event or motion event has been detected and the minimum reporting time interval has elapsed since the last report (if this is not the first event report); (ii) a requested periodic location event has occurred; or (iii) the maximum reporting time for an area event or motion event has expired. When a trigger or periodic event is detected and if the UE is camped on or connected to (or can otherwise access) an access type allowed by the LMF at step 16, the UE proceeds to step 23. If the UE cannot access an allowed access type, the UE may skip reporting the trigger event or may report the trigger event at a later time when an allowed access type becomes available, according to requirements received from the LMF at step 16. When a scheduled location time is provided for periodic location request at step 16, a UE should perform steps 23-25 some time in advance of the scheduled location time for the first periodic event report or some time in advance of the periodic interval expiration for each succeeding periodic event report in order to enable location measurements at step 23 or step 27 to occur near to each of these times, respectively.
23. The UE obtains any location measurements or a location estimate that were requested or allowed at step 16.
NOTE 6: Obtaining a location estimate when requested also applies to the trigger event corresponding to expiration of the maximum reporting interval for an area event or motion event.
24. The UE performs a UE triggered service request as defined in clause 4.2.3.2 of TS 23.502 if in CM-IDLE state in order to establish a signalling connection with the AMF.
25. The UE sends a supplementary services event report message to the LMF which is transferred via the serving AMF (which may be different to the original serving AMF for steps 14-16) and is delivered to the LMF using an Namf_Communication_N1MessageNotify service operation. The event report may indicate the type of event being reported (e.g. whether a normal event or expiration of the maximum reporting interval) and may include embedded positioning message(s) which includes any location measurements or location estimate and the timestamp of the location estimate if available obtained at step 23. The UE also includes the deferred routing identifier received in step 16 in the NAS Transport message used to transfer the event report from the UE to the AMF. The AMF then forwards the event report to either the serving LMF or any suitable LMF based on whether the deferred routing identifier indicates a particular LMF or any (default) LMF. If a different LMF than the serving LMF is used, procedure in clause 6.4 is used. The UE also includes the (H)GMLC contact address, the LDR reference number, whether location estimates are to be reported and if so the location QoS in the event report and any scheduled location time indicated at step 16 for periodic reporting.
NOTE 7: When forwarding the event report message to the LMF in step 25, the AMF includes the deferred routing identifier received in step 25 as the LCS Correlation Identifier. The deferred routing identifier can assist a serving LMF in identifying the periodic or triggered location session if the same serving LMF had assigned the deferred routing identifier at step 16 or can indicate to the LMF that it is acting as a default LMF.
NOTE 8: The scheduled location time included at step 25 equals T+(N−1)*P, where T is the initial Scheduled Location Time, N is the Report Number (N≥1) and P is the time interval between successive periodic events.
26. When the LMF receives the event report and if it can handle this event report, the LMF updates the status of event reporting (e.g. the number of event reports so far received from the UE and/or the duration of event reporting so far) and returns a supplementary services acknowledgment for the event report to the UE. The acknowledgment may optionally include a new deferred routing identifier indicating a new serving LMF or a default (any) LMF. If the UE does not receive any response from the LMF after a predefined time, i.e. the current LMF does not support the deferred location request (for temporary or permanent reasons) or due to some radio access failures, the UE may re-send the report one or more times. If the UE sends the repeated event report more than the predefined maximum resending time and the UE still does not receive any response from AMF, the UE shall stop resending the report and reserve the event report, then record a corresponding flag to indicate that a report has been sent unsuccessfully. When the UE performs location update and detects the PLMN is changed, if the flag has been set, the UE shall send the report to the corresponding AMF, and the flag will be cleared upon a success of the sending.
NOTE 9: Inclusion of a new deferred routing identifier in the event report acknowledgment at step 26 may be used to change the serving LMF (e.g. if a UE moves into an area or to an access type that is better supported by a different LMF or if the serving LMF is overloaded) or to enable a default LMF to become a serving LMF.
27. If a location estimate is needed for event reporting, the LMF may perform one or more of the positioning procedures described in clause 6.11.1, 6.11.2 and 6.11.3 and as described for step 8 in clause 6.1.1 and step 12 in clause 6.1.2. The LMF then determines the UE location using the location measurements and/or location estimate(s) obtained at this step and/or received at step 25. The LMF may also determine the timestamp of the location estimate.
NOTE 10: A precondition for the procedure in clause 6.11.1 is that an LCS Correlation identifier assigned by the serving AMF has been previously passed to the LMF. The LCS Correlation identifier is used in steps 1, 3, 6 and 7 in clause 6.11.1 to ensure that during a positioning session between the LMF and UE, positioning response messages from the UE are returned by the AMF to the correct LMF and carrying an indication (the LCS Correlation identifier) which can be recognized by the LMF. To retain this capability in step 27, the LMF shall assign a Correlation identifier indicating the LMF (and optionally a positioning session) for use at step 1 in clause 6.11.1. To enable an AMF to distinguish a Correlation identifier assigned by an LMF (used in this procedure) from a Correlation identifier assigned by the AMF (used otherwise for clause 6.11.1), the two types of Correlation identifier could be selected from different ranges, with or without a flag.
28. In the case of roaming, the LMF selects a VGMLC (which may be different to the VGMLC for steps 3-8 and steps 19-21). The LMF then invokes an NImf_Location_EventNotify service operation towards the selected VGMLC or (H)GMLC with an indication of the type of event being reported, the (H)GMLC contact address and LDR reference number, the identification of the LMF if this is a serving LMF, and any location estimate and the timestamp of the location estimate (if available) obtained at step 27. If multiple QoS class was used in the initial location request, the LMF provides the achieved Location QOS Accuracy in step 27.
NOTE 11: In the case of roaming, the LMF may select the VGMLC for step 28 using the NRF service or using configuration information in the LMF or may use the same VGMLC as for steps 3-8 (e.g. if the LMF acts as a serving LMF and received the VGMLC address from the AMF as part of step 14).
29. This step is skipped for a non-roaming UE. For a roaming UE, the VGMLC invokes an Ngmlc_Location_EventNotify service operation to forward the information received in step 28 (e.g. including the type of event being reported, the LDR reference number and possibly the LMF identification) to the HGMLC which identifies the periodic and triggered location request from the LDR reference number.
NOTE 12: As an optional optimization for a roaming UE, instead of performing steps 28 and 29, the LMF may invoke the NImf_Location_EventNotify service operation directly towards the HGMLC.
NOTE 13: In the event of mobility of the UE to an access network for which event reporting at step 22 is not allowed (e.g. an access network in EPS) or if the UE is otherwise unable to send event reports (e.g. due to being powered off), the (H)GMLC may not receive event reports at step 28 or step 29 at fixed intervals for periodic location or at intervals equal to or less than the maximum reporting interval for triggered location. In such a case, the (H)GMLC may cancel the periodic or triggered location reporting using the procedures defined in clause 6.3.3. The UE may also cancel the periodic or triggered location reporting either locally or using the procedure defined in clause 6.3.2 once the UE can access an access network that is allowed for event reporting.
30. The (H)GMLC uses the LDR reference number received in step 28 or step 29 to identify the periodic and triggered location request received in step 1 and then sends the type of event being reported and any location estimate and the timestamp of the location estimate (if available) and used positioning methods to the external LCS client or AF (via the NEF), and sends the LDR reference number to LCS client. The (H)GMLC may also verify UE privacy requirements before reporting the event and any location to the external LCS client or AF. If multiple QoS class was used in the initial location request, the LMF provides the achieved Location QoS Accuracy in step 27.
31. The UE continues to monitor for further periodic or trigger events as in step 22 and instigates steps 23-30 each time a trigger event is detected.
NOTE 14: Service continuity for reporting of periodic or trigger events when a UE moves between 5GS and EPS is not supported in this release of the specification.

A Positioning Reference Unit (PRU) at a known location can perform positioning measurements (e.g., RSTD, RSRP, UE Rx-Tx Time Difference measurements, etc.) and report these measurements to a location server. In addition, the PRU can transmit SRS to enable TRPs to measure and report UL positioning measurements (e.g., RTOA, UL-AoA, gNB Rx-Tx Time Difference, etc.) from PRU at a known location. The PRU measurements can be compared by a location server with the measurements expected at the known PRU location to determine correction terms for other nearby target devices. The DL-and/or UL location measurements for other target devices can then be corrected based on the previously determined correction terms.

From a location server perspective, the PRU functionality is realized by a UE with known location. 3GPP TR 23.700-71 captures options for PRU management, illustrated in FIG. 3. The PRU management procedure is used by 5GC to obtain the PRU information and to become aware which PRU(s)) are available in the network. To manage PRU, three options could be considered:
Option A: PRU registration to AMF.
Option B.1: PRU registration to LMF.
Option B.2: LMF obtains available PRU information via LPP procedures.
Option C: PRU information are pre-configured in the UDM.

### Option A: PRU Registration to AMF

1a~2a. PRU initiate the registration procedure to the AMF, including the PRU capability as well as the User Location Information (i.e. CGI and TAI). The PRU may also include the mobility state (e.g. mobile or static) in its registration, so AMF can maintain all the available PRU with related information dynamically.
3a. After receiving the PRU information, the AMF invokes the Nnrf_NFManagement_NFUpdate Request (PRU location, PRU existence indication) to NRF to indicate the PRU existence in certain areas (e.g. in one or multiple TAI(s)).

### Option B.1: PRU Registration to LMF

1b~2b. The UE provides an indication to the serving AMF whether it can function as a PRU. The serving AMF then registers the PRU to an LMF.
3b. After receiving the PRU information, the LMF invokes the Nnrf_NFManagement_NFUpdate Request (PRU location, PRU existence indication) to NRF to indicate the PRU existence in certain areas (e.g. in one or multiple TAI(s)).

### Option B.2: PRU Registration to LMF

1b. LMF obtains available PRU information via LPP procedures.
2b. This step is same as step 3b in OptionB.1.

### Option C: PRUs Information are Maintained at the UDM

A UE may be pre-configured as a PRU with the PRU information included in the UE subscription data as a new parameter set and stored in Unified Data Management (UDM).

There currently exist certain challenges. For example, SA2 is discussing how PRU registration is done and how LMF generated correlation ID would be used to communicate with PRU. This also gives capability to LMF to initiate positioning towards PRU. Currently, the positioning is initiated by external client/LCS client or the UE or AMF for emergency calls, i.e., LMF itself cannot initiate the positioning. A rouge LMF may create a wrong correlation ID which may point to a UE or SUPI which is not a PRU.

### SUMMARY

Certain aspects of the disclosure and their embodiments may provide solutions to these or other challenges. For example, embodiments of this disclosure may provide authorization to ensure that a PRU location request is only allowed or processed for authorized PRU and not for any non-PRU or regular device or UE.

A first example aspect of embodiments of this disclosure provides a method in a first network node for a network assisted positioning procedure. The method comprises receiving, from a second network node, a request for a location of a User Equipment (UE), wherein the request indicates that the UE is a Positioning Reference Unit (PRU) and the request includes a correlation identifier; and determining, based on the correlation identifier, whether the UE is a PRU.

Another example aspect of embodiments of this disclosure provides apparatus in a first network node for a network assisted positioning procedure. The apparatus comprises a processor and a memory. The memory contains instructions executable by the processor such that the apparatus is operable to receive, from a second network node, a request for a location of a UE, wherein the request indicates that the UE is a Positioning Reference Unit (PRU) and the request includes a correlation identifier; and determine, based on the correlation identifier, whether the UE is a PRU.

Certain embodiments may provide one or more of the following technical advantage(s). For example, authorization of the correlation ID of the PRU device for example may ensure that the LMF triggered positioning request has no privacy/security issues while initiating positioning, or ensure the positioning is towards a valid PRU (e.g. a UE with a valid PRU subscription) and not any real (non-PRU) UE or fake UE.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates NG-RAN Release 15 LCS protocols;

FIG. 2 illustrates the initiation and reporting of location events for a deferred 5GC-MT-LR procedure for Periodic, Triggered and UE Available Location Events;

FIG. 3 illustrates options for PRU management;

FIG. 4 shows a method performed by a network node according to embodiments of the disclosure;

FIG. 5 illustrates an example of a network assisted location procedure;

FIG. 6 shows an example of a procedure that may be used by an LMF to support network assisted and network based positioning;

FIG. 7 shows an example of a communication system in accordance with some embodiments;

FIG. 8 shows a UE in accordance with some embodiments;

FIG. 9 shows a network node in accordance with some embodiments;

FIG. 10 is a block diagram of a host in accordance with various aspects described herein;

FIG. 11 is a block diagram illustrating a virtualization environment in which functions implemented by some embodiments may be virtualized;

FIG. 12 shows a communication diagram of a host communicating via a network node with a UE over a partially wireless connection in accordance with some embodiments; and

FIG. 13 shows a network node in accordance with further embodiments.

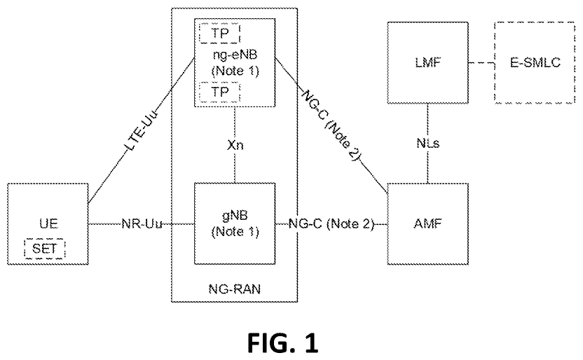

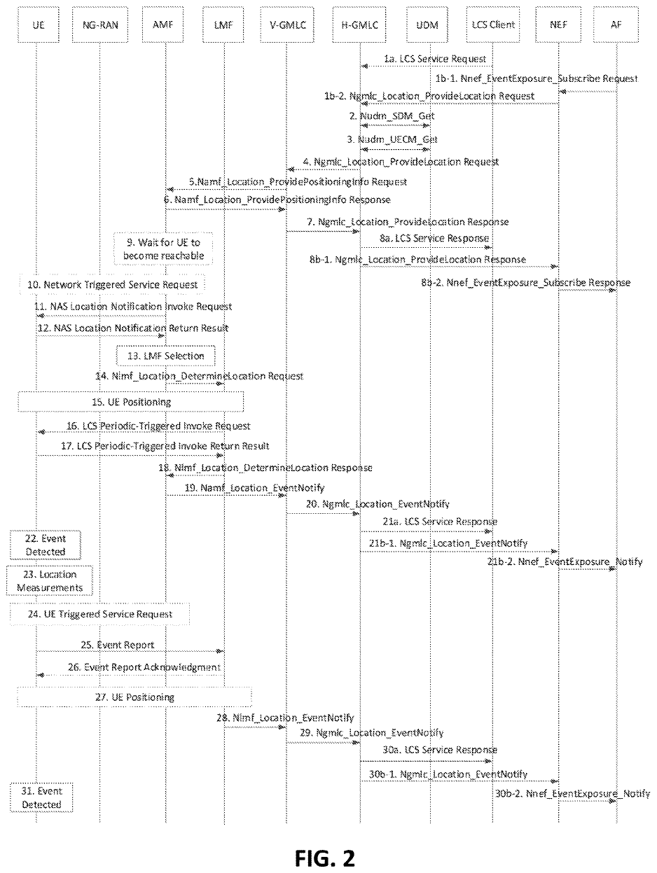

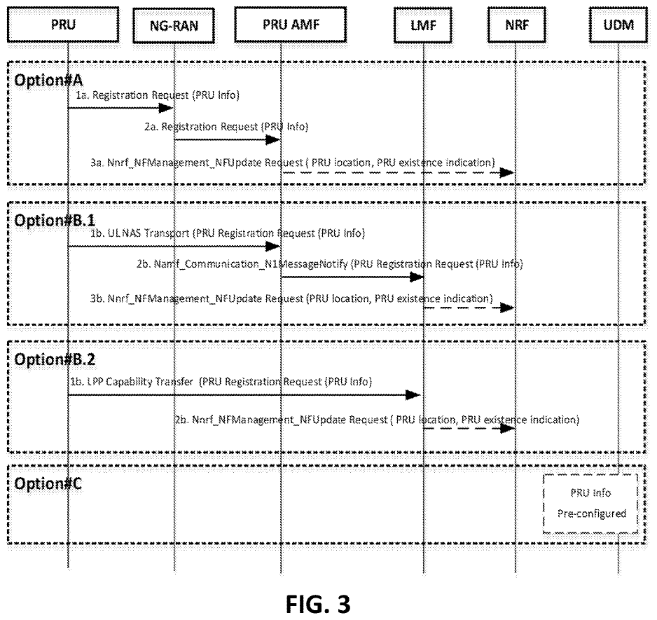

### DETAILED DESCRIPTION OF EXAMPLE EMBODIMENTS

Some of the embodiments contemplated herein will now be described more fully with reference to the accompanying drawings. Embodiments are provided by way of example to convey the scope of the subject matter to those skilled in the art.

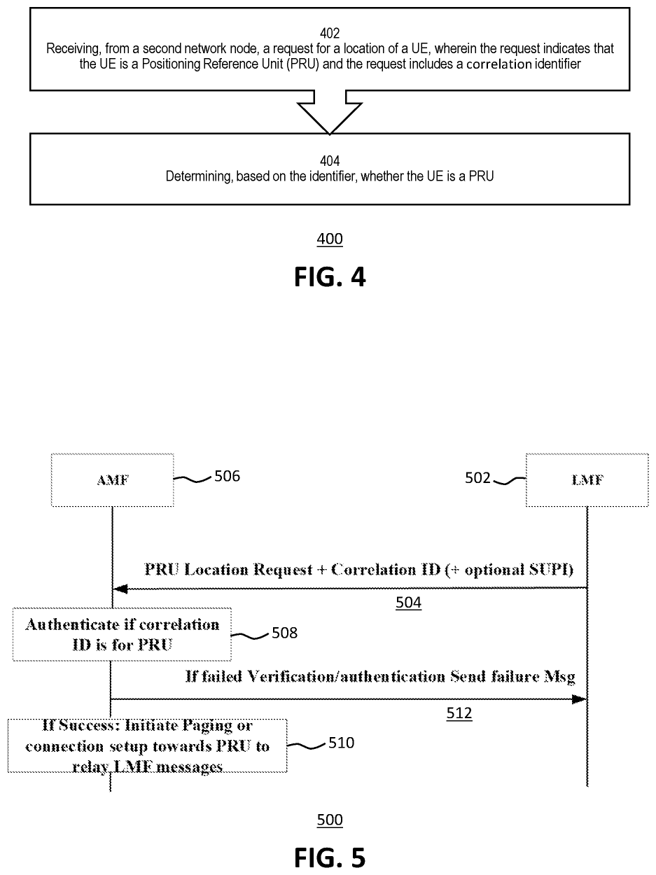

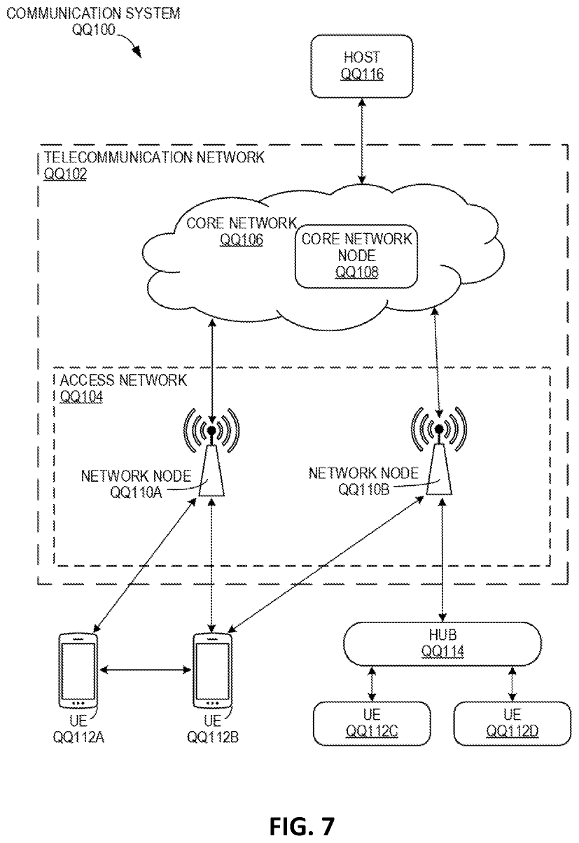

FIG. 4 depicts a method in accordance with particular embodiments, such as for example a method 400 in a first network node for a network assisted positioning procedure. The method 400 may be performed by a network node (e.g. the network node QQ110 or network node QQ300 as described later with reference to FIGS. 7 and 9 respectively), which may be a core network node, an AMF, RAN node (e.g. base station) or any other network node. The method begins at step 402 with receiving, from a second network node (e.g. a Location Management Function, LMF), a request for a location of a UE, wherein the request indicates that the UE is a Positioning Reference Unit (PRU) and the request includes a correlation identifier, such as for example a LCS correlation ID. Step 404 of the method 400 comprises determining, based on the correlation identifier, whether the UE is a PRU (e.g. a valid PRU).

In some examples, the method 400 comprises, if the UE is a PRU, forwarding the request for the location of the UE to a Radio Access network (RAN) associated with the UE, and/or forwarding, to the second network node, results of measurements triggered by the request for the location of the UE. Alternatively, for example, if the UE is not a PRU, the method 400 may comprise one or more of the following: sending an indication to the second network node that the request for the location of the UE has failed; refraining from forwarding the request for the location of the UE to a Radio Access network (RAN) associated with the UE; and/or refraining from forwarding, to the second network node, results of measurements triggered by the request for the location of the UE. Thus for example the location of the UE/PRU will only be forwarded to the second network node if the UE is a PRU (or a valid PRU).

In some examples, determining whether the UE is a PRU in step 402 may comprise determining whether a registration request to register as a PRU has been received from the UE, and/or determining whether the UE is a PRU from data stored in a network data storage node, such as a Unified Data Management (UDM) or a Unified Data Repository (UDF).

The method 400 may also in some examples comprise determining that the request for the location of the UE is a request for the location of a PRU. Additionally, in some examples, the method 400 may comprise determining that the request for the location of the UE is a request for the location of a PRU by determining that a flag in the request for the location of the UE indicates that the request for the location of the UE is a request for the location of a PRU.

Determining that the request for the location of the UE is a request for the location of a PRU may in some examples comprise determining that at least a portion of the correlation identifier is within a predetermined range. For example, the predetermined range is reserved for requests for the location of a PRU, whereas values outside of the predetermined range may be for requests for non-PRU UEs or other devices. Additionally or alternatively, the correlation identifier may include an identifier of the UE in some examples. This may be for example a Subscription Permanent Identifier (SUPI) and/or a Generic Public Subscription Identifier (GPSI).

The correlation identifier may include an identifier of a serving Location Management Function (LMF) of the UE in some examples.

Determining that the request for the location of the UE is a request for the location of a PRU in step 402 may in some examples comprise determining whether the identifier was generated or assigned by the first network node.

Particular illustrative example embodiments are now described.

In some examples, a UE as PRU may register to an AMF and informs it that it is a PRU. The AMF may for example authenticate (e.g. may check UE subscription or previously received registration request) and forward the UE/PRU information to the LMF, where the information may for example identify the UE/PRU and/or include information for communicating with the UE/PRU. LMF may for example register the PRU and create a correlation ID, or the AMF may create the correlation ID, or the correlation ID may be determined in accordance with some rules, e.g. constructed from LMF ID and UE/PRU ID.

The AMF may in some examples verify that the sender of the PRU Registration Request is a PRU using subscription information from the UDM.

The AMF may in some examples select the serving LMF (e.g. based on the current Tracking Area Indication) and transfer the PRU Registration Request to the serving LMF using an Namf_Communication_N1MessageNotify service operation. The AMF includes in the service operation an indication that the PRU was verified by the AMF. The AMF also includes the Subscription Permanent Identifier (SUPI) of the PRU.

The serving LMF may for example authenticate the PRU. This can be based on an indication that the PRU was verified by the AMF or may be based on matching the SUPI for the PRU received prior with a corresponding SUPI configured in the LMF.

FIG. 5 illustrates an example of a network assisted location procedure where location of a UE is determined by means of obtaining measurements from a network node (e.g. serving gNB). This procedure may in some examples also be or incorporate a method of verifying or authenticating a request for a location of a PRU (e.g. verifying or authenticating that the PRU is a valid PRU) according to examples of this disclosure. In this example shown in FIG. 5, if a LMF 502 has a need to trigger/initiate positioning towards a PRU, it sends a request 504 to the AMF 506 and identifies the correlation ID (e.g. LCS correlation ID) associated with the PRU. The LMF 502 may in some examples generate the correlation ID in this example, if not previously obtained from the AMF 506 during the registration of the PRU. Further, in some examples, if the correlation ID cannot identify the LMF 504 and UE then the LMF 502 may also include the an identifier of the UE in the request 504 (e.g. Subscription Permanent Identifier, SUPI, and/or Generic Public Subscription Identifier, GPSI).

In step 508, the AMF 506 authenticates if the correlation ID is for a valid PRU. In some examples, the AMF 502 may send a request to UDM. UDM may verify that the UE is a PRU, for example based on a subscription associated with the UE. The UDM sends the response to the AMF 506.

Once verified, the AMF progresses further to setup connection with PRU in step 510. Alternatively, if verification failed, the AMF 506 sends a message 512 to the LMF 502 indicating that verification failed.

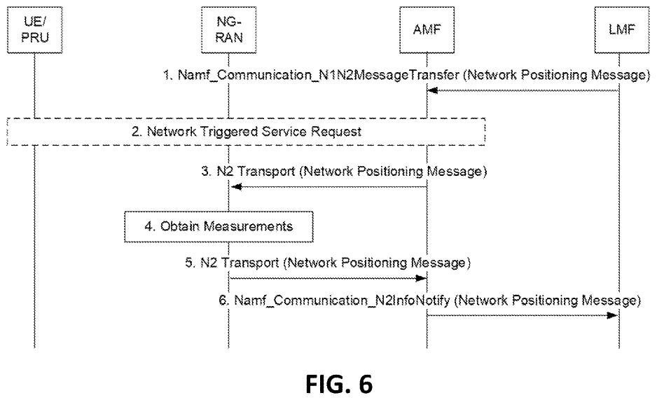

FIG. 6 shows an example of a procedure that may be used by an LMF to support network assisted and network based positioning according to examples of this disclosure, and may include a method of receiving a request for a location of a UE for a network assisted positioning procedure, and may in some examples comprise validating, verifying or authenticating that the UE is a valid PRU. The procedure may be based for example on an NRPPa protocol in 3GPP TS 38.455 V 17.3.0 between the LMF and NG-RAN.

The example procedure may include one or more of the following steps:
Precondition: A LCS Correlation identifier and the AMF identity have been passed to the LMF by the serving AMF. In case of PRU, LCS Correlation identifier is generated by LMF and provided to AMF during PRU Registration Accept message.
1. The LMF invokes the Namf_Communication_N1N2MessageTransfer service operation towards the AMF to request the transfer of a Network Positioning message to the serving NG-RAN node (gNB or ng-eNB) for the UE. The service operation includes the Network Positioning message, indicates if the positioning is initiated towards a PRU, and the LCS Correlation identifier (which may in some examples be used to indicate if the positioning is initiated towards a PRU, similar to examples described above). The Network Positioning message may request location information for the UE from the NG-RAN.
2. If the UE is in CM IDLE state, the AMF performs a network triggered Service Request procedure as defined in clause 4.2.3.3 of TS 23.502 V18.0.0, to establish a signalling connection with the UE. For PRU positioning case, AMF verifies the LCS Correlation identifier is associated to a valid PRU before initiating the procedure.
3. The AMF forwards the Network Positioning message to the serving NG-RAN node in an N2 Transport message. The AMF includes a Routing identifier, in the N2 Transport message, identifying the LMF (e.g. a global address of the LMF).
4. The serving NG-RAN node obtains any location information for the UE requested in step 3.
5 The serving NG-RAN node returns any location information obtained in step 4 to the AMF in a Network Positioning message included in an N2 Transport message. The serving NG-RAN node shall also include the Routing identifier in the N2 Transport message received in step 3.
6. The AMF invokes the Namf_Communication_N2InfoNotify service towards the LMF indicated by the routing identifier received in step 5. The service operation includes the Network Positioning message received in step 5 and the LCS Correlation identifier.

Steps 1 to 6 may be repeated to request further location information and further NG-RAN capabilities.

Based on 3GPP TS 29.572V16.9.0 , LCS Correlation ID shall be of a minimum length of 1 character and maximum length of 255 characters. In some example embodiments, a correlation ID range may be reserved to be used for PRU location requests. Additionally or alternatively, for example, the correlation ID for PRU can be indicated using a flag, e.g. in a location request. That is, the recipient (e.g. AMF) understands from the correlation ID or the flag that it is for a location of a PRU.

In some example embodiments, the correlation ID is designed in a way that PRU ID and serving LMF ID can be determined from correlation ID. For example, these IDs may be concatenated in the correlation ID or otherwise included in or derivable from the correlation ID. For example:
Correlation ID=Serving LMF ID+UE Identity (e.g. SUPI/GPSI of PRU) Here, the ‘+’ operation may be a concatenation operation. Thus, for example, the correlation ID can be an integer comprising the LMF and UE IDs, where fixed ID lengths are used for each so the receiver (e.g. AMF) can decode them unambiguously. This correlation ID can also be converted into a string in some examples:
Correlation ID=String Conversion (Serving LMF ID+UE Identity) To delineate the LMF ID and UE ID, a fixed integer value length (e.g. fixed number of bits/bytes, etc) may considered for both of these IDs in some examples, so that the receiver (e.g. AMF) can distinguish how they can be extracted unambiguously.

In some example embodiments, the correlation ID may be scrambled (e.g. ciphered, encrypted, etc) and the keys shared between LMF and AMF beforehand (before sending the correlation ID info), to allow decoding/deciphering/decrypting of the correlation ID.

FIG. 7 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108.

Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 7, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

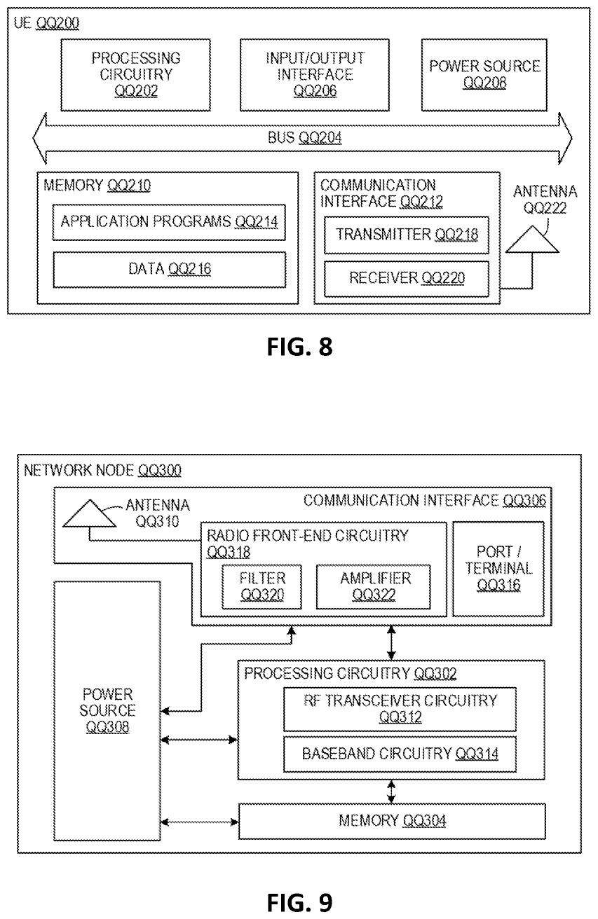

FIG. 8 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIG. 4.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection.

The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 9 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

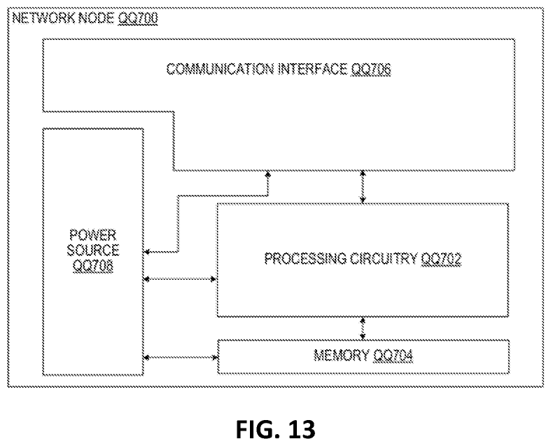

FIG. 13 shows a network node QQ700 in accordance with some embodiments. As used herein, network node refers to equipment capable, configured, arranged and/or operable to communicate directly or indirectly with a UE and/or with other network nodes or equipment, in a telecommunication network. The network node QQ700 may be operable as a core network node, a core network function or, more generally, a core network entity, such as the core network node QQ108 described above with respect to FIG. 7). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node QQ700 includes processing circuitry QQ702, a memory QQ704, a communication interface QQ706, and a power source QQ708, and/or any other component, or any combination thereof. The network node QQ700 may be composed of multiple physically separate components, which may each have their own respective components. In certain scenarios in which the network node QQ700 comprises multiple separate components, one or more of the separate components may be shared among several network nodes.

The processing circuitry QQ702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ700 components, such as the memory QQ704, network node QQ700 functionality. For example, the processing circuitry QQ702 may be configured to cause the network node to perform the methods as described with reference to FIG. 4.

The memory QQ704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ702. The memory QQ704 may store any suitable instructions, data, or information, including a computer program, software, an application including one or more of logic, rules, code, tables, and/or other instructions capable of being executed by the processing circuitry QQ702 and utilized by the network node QQ700. The memory QQ704 may be used to store any calculations made by the processing circuitry QQ702 and/or any data received via the communication interface QQ706. In some embodiments, the processing circuitry QQ702 and memory QQ704 is integrated.

The communication interface QQ706 is used in wired or wireless communication of signaling and/or data between a network node, access network, and/or UE.

The power source QQ708 provides power to the various components of network node QQ700 in a form suitable for the respective components (e.g., at a voltage and current level needed for each respective component). The power source QQ708 may further comprise, or be coupled to, power management circuitry to supply the components of the network node QQ700 with power for performing the functionality described herein. For example, the network node QQ700 may be connectable to an external power source (e.g., the power grid, an electricity outlet) via an input circuitry or interface such as an electrical cable, whereby the external power source supplies power to power circuitry of the power source QQ708. As a further example, the power source QQ708 may comprise a source of power in the form of a battery or battery pack which is connected to, or integrated in, power circuitry. The battery may provide backup power should the external power source fail.

Embodiments of the network node QQ700 may include additional components beyond those shown in FIG. 13 for providing certain aspects of the network node's functionality, including any of the functionality described herein and/or any functionality necessary to support the subject matter described herein. For example, the network node QQ700 may include user interface equipment to allow input of information into the network node QQ700 and to allow output of information from the network node QQ700. This may allow a user to perform diagnostic, maintenance, repair, and other administrative functions for the network node QQ700.

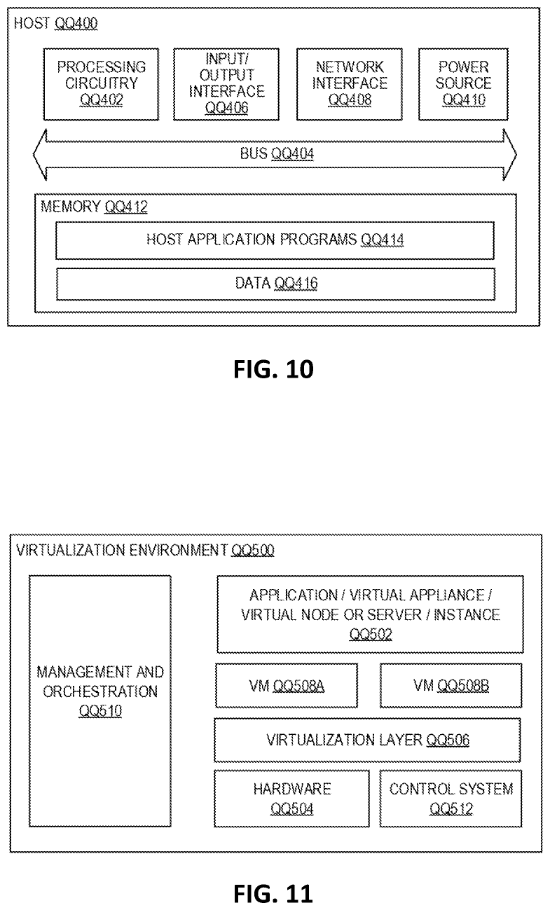

FIG. 10 is a block diagram of a host QQ400, which may be an embodiment of the host QQ116 of FIG. 7, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 8 and 9, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

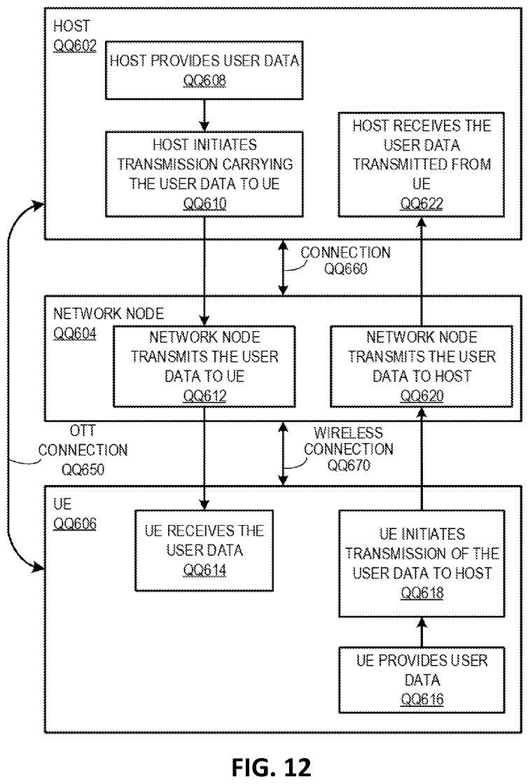

FIG. 12 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 7 and/or UE QQ200 of FIG. 8), network node (such as network node QQ110a of FIG. 7 and/or network node QQ300 of FIG. 9), and host (such as host QQ116 of FIG. 7 and/or host QQ400 of FIG. 10) discussed in the preceding paragraphs will now be described with reference to FIG. 12.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 7) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve network security and/or privacy.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc. ; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602.

The measurements may be implemented in that software causes messages to be transmitted, in particular empty or ‘dummy’ messages, using the OTT connection QQ650 while monitoring propagation times, errors, etc.

This disclosure includes the following enumerated embodiments:
1. A method in a first network node of receiving a request for a location of a User Equipment (UE), the method comprising:
   receiving, from a second network node, a request for a location of a UE, wherein the request indicates that the UE is a Positioning Reference Unit (PRU) and the request includes an identifier; and
   determining, based on the identifier, whether the UE is a PRU.
2. The method of embodiment 1, comprising, if the UE is a PRU, forwarding the request for the location of the UE to a Radio Access network (RAN) associated with the UE, and/or forwarding, to the second network node, results of measurements triggered by the request for the location of the UE.
3. The method of embodiment 1 or 2, comprising, if the UE is not a PRU:
   sending an indication to the second network node that the request for the location of the UE has failed;
   refraining from forwarding the request for the location of the UE to a Radio Access network (RAN) associated with the UE; and/or
   refraining from forwarding, to the second network node, results of measurements triggered by the request for the location of the UE.
4. The method of any of embodiments 1 to 3, wherein determining whether the UE is a PRU comprises determining whether the UE is a valid PRU.
5. The method of any of embodiments 1 to 4, wherein determining whether the UE is a PRU comprises one or more of:
   determining whether a registration request to register as a PRU has been received from the UE;
   determining whether the UE is a PRU from data stored in a network data storage node.
6. The method of embodiment 5, wherein the network data storage node comprises a Unified Data Management (UDM) or a Unified Data Repository (UDF).
7. The method of any of embodiments 1 to 6, comprising determining that the request for the location of the UE is a request for the location of a PRU.
8. The method of embodiment 7, comprising determining that the request for the location of the UE is a request for the location of a PRU by determining that a flag in the request for the location of the UE indicates that the request for the location of the UE is a request for the location of a PRU.
9. The method of any of embodiments 1 to 8, wherein the identifier comprises a correlation identifier.
10. The method of embodiment 9, wherein the correlation identifier comprises a Location Services (LCS) correlation identifier.
11. The method of any of embodiments 1 to 10, wherein determining that the request for the location of the UE is a request for the location of a PRU comprises determining that at least a portion of the identifier is within a predetermined range.
12. The method of embodiment 11, wherein the predetermined range is reserved for requests for the location of a PRU.
13. The method of any of embodiments 1 to 12, wherein the identifier includes an identifier of the UE.
14. The method of embodiment 13, wherein the identifier of the UE comprises a Subscription Permanent Identifier (SUPI) and/or a Generic Public Subscription Identifier (GPSI).
15. The method of any of embodiments 1 to 14, wherein the identifier includes an identifier of a serving Location Management Function (LMF) of the UE.
16. The method of any of embodiments 1 to 15, wherein determining that the request for the location of the UE is a request for the location of a PRU comprises determining whether the identifier was generated or assigned by the first network node.
17. The method of any of embodiments 1 to 16, wherein the first network node comprises a core network node, an Access and Mobility Management Function (AMF) or a Radio Access Network (RAN) node. 18. The method of any of embodiments 1 to 17, wherein the second network node comprises a Location Management Function (LMF).
19. A computer program comprising instructions which, when executed on at least one processor, cause the at least one processor to carry out a method according to any of claims 1 to 15.
20. A carrier containing a computer program according to claim 16, wherein the carrier comprises one of an electronic signal, optical signal, radio signal or computer readable storage medium.
21. A computer program product comprising non transitory computer readable media having stored thereon a computer program according to claim 16.
22. Apparatus in a first network node of receiving a request for a location of a User Equipment (UE), the apparatus comprising a processor and a memory, the memory containing instructions executable by the processor such that the apparatus is operable to:
   receive, from a second network node, a request for a location of a UE, wherein the request indicates that the UE is a Positioning Reference Unit (PRU) and the request includes an identifier; and
   determine, based on the identifier, whether the UE is a PRU.
23. The apparatus of embodiment 22, wherein the memory contains instructions executable by the processor such that the apparatus is operable to, if the UE is a PRU, forward the request for the location of the UE to a Radio Access network (RAN) associated with the UE, and/or forward, to the second network node, results of measurements triggered by the request for the location of the UE.
24. The apparatus of embodiment 22 or 23, wherein the memory contains instructions executable by the processor such that the apparatus is operable to, if the UE is not a PRU:
   send an indication to the second network node that the request for the location of the UE has failed;
   refrain from forwarding the request for the location of the UE to a Radio Access network (RAN) associated with the UE; and/or
   refrain from forwarding, to the second network node, results of measurements triggered by the request for the location of the UE.
25. The apparatus of any of embodiments 22 to 24, wherein the memory contains instructions executable by the processor such that the apparatus is operable to determiner whether the UE is a PRU by determining whether the UE is a valid PRU.
26. The apparatus of any of embodiments 22 to 25, wherein the memory contains instructions executable by the processor such that the apparatus is operable to determine whether the UE is a PRU by one or more of:
   determining whether a registration request to register as a PRU has been received from the UE;
   determining whether the UE is a PRU from data stored in a network data storage node.
27. The apparatus of embodiment 26, wherein the network data storage node comprises a Unified Data Management (UDM) or a Unified Data Repository (UDF).
28. The apparatus of any of embodiments 22 to 27, wherein the memory contains instructions executable by the processor such that the apparatus is operable to determine that the request for the location of the UE is a request for the location of a PRU.
29. The apparatus of embodiment 28, wherein the memory contains instructions executable by the processor such that the apparatus is operable to determine that the request for the location of the UE is a request for the location of a PRU by determining that a flag in the request for the location of the UE indicates that the request for the location of the UE is a request for the location of a PRU.
30. The apparatus of any of embodiments 22 to 29, wherein the identifier comprises a correlation identifier.
31. The apparatus of embodiment 30, wherein the correlation identifier comprises a Location Services (LCS) correlation identifier.
32. The apparatus of any of embodiments 22 to 31, wherein the memory contains instructions executable by the processor such that the apparatus is operable to determine that the request for the location of the UE is a request for the location of a PRU by determining that at least a portion of the identifier is within a predetermined range.
33. The apparatus of embodiment 32, wherein the predetermined range is reserved for requests for the location of a PRU.
34. The apparatus of any of embodiments 22 to 33, wherein the identifier includes an identifier of the UE.
35. The apparatus of embodiment 34, wherein the identifier of the UE comprises a Subscription Permanent Identifier (SUPI) and/or a Generic Public Subscription Identifier (GPSI).
36. The apparatus of any of embodiments 22 to 35, wherein the identifier includes an identifier of a serving Location Management Function (LMF) of the UE.
37. The apparatus of any of embodiments 22 to 36, wherein the memory contains instructions executable by the processor such that the apparatus is operable to determine that the request for the location of the UE is a request for the location of a PRU by determining whether the identifier was generated or assigned by the first network node.
38. The apparatus of any of embodiments 22 to 37, wherein the first network node comprises or is comprised in a core network node, an Access and Mobility Management Function (AMF) or a Radio Access Network (RAN) node.
39. The apparatus of any of embodiments 22 to 38, wherein the second network node comprises a Location Management Function (LMF).
40. A first network node for receiving a request for a location of a User Equipment (UE), the network node comprising:
   processing circuitry configured to cause the first network node to perform any of the steps of any of embodiments 1 to 18;
   power supply circuitry configured to supply power to the processing circuitry.
41. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of embodiments 1 to 18 to transmit the user data from the host to the UE.
42. The host of the previous embodiment, wherein:
   the processing circuitry of the host is configured to execute a host application that provides the user data; and
   the UE comprises processing circuitry configured to execute a client application associated with the host application to receive the transmission of user data from the host.
43. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of embodiments 1 to 18 to transmit the user data from the host to the UE.
44 The method of the previous embodiment, further comprising, at the network node, transmitting the user data provided by the host for the UE.
45. The method of any of the previous 2 embodiments, wherein the user data is provided at the host by executing a host application that interacts with a client application executing on the UE, the client application being associated with the host application.
46. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of embodiments 1 to 18 to transmit the user data from the host to the UE.
47. The communication system of the previous embodiment, further comprising:
   the network node; and/or
   the user equipment.
48. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of embodiments 1 to 18 to receive the user data from a user equipment (UE) for the host.
49. The host of the previous embodiment, wherein:
   the processing circuitry of the host is configured to execute a host application, thereby providing the user data; and
   the host application is configured to interact with a client application executing on the UE, the client application being associated with the host application.
50. The host of the any of the previous 2 embodiments, wherein the initiating receipt of the user data comprises requesting the user data.
51. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of embodiments 1 to 18 to receive the user data from the UE for the host.
   The method of the previous embodiment, further comprising at the network node, transmitting the received user data to the host.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-34. (canceled)

35. A method in a first network node for a network assisted positioning procedure, the method comprising:
receiving, from a second network node, a request for a location of a User Equipment (UE), wherein the request indicates that the UE is a Positioning Reference Unit (PRU) and the request includes a correlation identifier; and
determining, based on the correlation identifier, whether the UE is a PRU.

36. The method of claim 35, comprising, responsive to determining that the UE is a PRU, performing at least one of:
forwarding the request for the location of the UE to a Radio Access network (RAN) associated with the UE;
forwarding, to the second network node, results of measurements triggered by the request for the location of the UE.

37. The method of claim 35, comprising, responsive to determining that the UE is not a PRU:
sending an indication to the second network node that the request for the location of the UE has failed; and
refraining from forwarding the request for the location of the UE to a Radio Access network (RAN) associated with the UE and/or refraining from forwarding, to the second network node, results of measurements triggered by the request for the location of the UE.

38. The method of any of claim 35, wherein determining whether the UE is a PRU comprises determining whether the UE is a valid PRU.

39. The method of any of claim 35, wherein determining whether the UE is a PRU comprises one or more of:
determining whether a registration request to register as a PRU has been received from the UE;
determining whether the UE is a PRU from data stored in a network data storage node.

40. The method of claim 39, wherein the network data storage node comprises a Unified Data Management (UDM) or a Unified Data Repository (UDF).

41. The method of any of claim 35, comprising determining that the request for the location of the UE is a request for the location of a PRU.

42. The method of claim 41, comprising determining that the request for the location of the UE is a request for the location of a PRU by determining that a flag in the request for the location of the UE indicates that the request for the location of the UE is a request for the location of a PRU.

43. The method of claim 35, wherein the correlation identifier comprises a Location Services (LCS) correlation identifier.

44. The method of any of claim 35, wherein determining whether the UE is a PRU comprises determining that at least a portion of the correlation identifier is within a predetermined range.

45. The method of claim 44, wherein the predetermined range is reserved for requests for the location of a PRU.

46. The method of claim 35, wherein the correlation identifier includes an identifier of the UE.

47. The method of claim 35, wherein the first network node comprises a core network node, an Access and Mobility Management Function (AMF) or a Radio Access Network (RAN) node.

48. The method of claim 35, wherein the second network node comprises a Location Management Function (LMF).

49. A first network node for a network assisted positioning procedure, the network node comprising:
processing circuitry configured to:
receive, from a second network node, a request for a location of a User Equipment (UE), wherein the request indicates that the UE is a Positioning Reference Unit (PRU) and the request includes a correlation identifier; and
determine, based on the correlation identifier, whether the UE is a PRU; and
power supply circuitry configured to supply power to the processing circuitry.

50. A method of operation by a network node in a cellular network, the method comprising:
receiving a request from a Location Management Function (LMF), requesting the location of a user equipment (UE) and indicating that the UE is a positioning reference unit (PRU);
verifying whether the UE is registered or subscribed in the cellular network as a PRU, based on evaluating a correlation identifier (ID) included in the request; and
responsive to verifying that the UE is registered as a PRU, forwarding the request towards a radio access network (RAN) of the cellular network, for determination and reporting of the location of the UE.
